(19) United States
(12) Patent Application Publication
(10) Pub. No.: US 2018/0135998 A1
(43) Pub. Date: May 17, 2018

(54) METHOD FOR IMPROVED USER EXPERIENCE DURING DRIVER DISTRACTION LOCKOUT MODES

(71) Applicant: Panasonic Automotive Systems Company of America, Division of Panasonic Corporation of North America, PEACHTREE CITY, GA (US)

(72) Inventors: ANNAMALAI PARAMASIVAM, NOVI, MI (US); ANANTHA KRISHNA CHANDRA, FARMINGTON HILLS, MI (US); JOHN HOLDREN, LIVONIA, MI (US)

(73) Assignee: Panasonic Automotive Systems Company of America, Division of Panasonic Corporation of North America

(21) Appl. No.: 15/811,845

(22) Filed: Nov. 14, 2017

Related U.S. Application Data
(60) Provisional application No. 62/422,949, filed on Nov. 16, 2016.

(51) Int. Cl. G01C 21/36; B60K 37/06; B60Q 9/00; G06F 3/02; G06F 3/16

(52) U.S. Cl. CPC G01C 21/3608; B60K 37/06; G06F 3/167; B60Q 9/00; G06F 3/0227; G01C 21/3664

(57) ABSTRACT

A method of enabling a driver to provide inputs to a vehicle while driving includes installing a tactile input device within the vehicle. A first portion of a set of inputs is received from the driver via the tactile input device. An increase in difficulty of a driving task of the driver is sensed. In response to the sensing step, the driver is automatically audibly prompted to enter a second portion of the set of inputs via an auditory input device. The second portion of the set of inputs is received from the driver via the auditory input device.

### CROSS-REFERENCE TO RELATED APPLICATION

This application claims benefit of U.S. Provisional Application No. 62/422,949 filed on Nov. 16, 2016, which the disclosure of which is hereby incorporated by reference in its entirety for all purposes.

### BACKGROUND OF THE INVENTION

### 1. Field of the Invention

The present invention relates to a method of enabling a driver to provide inputs to a vehicle while driving.

### 2. Description of the Related Art

Many infotainment systems incorporate a driver distraction lockout strategy in order to reduce driver workload and mitigate the risk of accidents caused by human error attributed to cognitive overload. However, these strategies are often disruptive to the user experience because they are not gracefully integrated and may even request the user to perform additional functions after a lockout notification is presented to the user.

Although known implementations provide the user with instructions to use the voice recognition system when certain features are disabled due to driver distraction lockout, they still require user input to actually do so and go through speech prompts to perform the action.

Automotive infotainment systems currently in production implement driver distraction restrictions as an important part of a user safety strategy. When the vehicle operates under prescribed conditions, which may include traveling above a speed threshold limit, or being in the Drive gear, the driver is restricted from performing certain operations using the touch screen interface in order to prevent accidents and keep the driver focused on the road. These functions are referred to as driver-restricted functions. When the user attempts such driver-restricted functions, current designs present an error message to the user, which results in zero task completion.

Most infotainment systems provide the user with the option to use a voice recognition system to access such driver restricted functions. The voice recognition session is initiated by pressing an external button, usually referred to as Push to Talk (PTT). The user has to manually start the voice recognition system, respond to the prompts, and then utter speech commands that invoke the desired functionality.

There are several limitations associated with the current state of the art. Known designs improve safety by limiting a user's attempts to access functions such as by disabling a keyboard for dialing a phone number or entering the destination address results in a moving vehicle. Typically, the user's attempt to access such functions results in an error or warning message in the display. This results in zero task completion and wasted driver efforts.

The wasted effort is even greater if the user initiated the function when the vehicle was stationary and then starts driving while the task is in progress. For example, the user may start typing in a destination address when the vehicle is stationary and then may begin driving the car. In such a scenario, known designs require the driver to abort the task and present an error message to the driver. Consequently, the driver's effort that went into the partial address entry is lost.

Known designs do provide voice recognition systems as an alternative to access the above functions in a moving vehicle. The user, after aborting the attempt using the touch interface can manually trigger the voice recognition system using a PTT button, listen to the prompts, navigate through the speech dialog structure if applicable and then utter the speech command to invoke the desired functionality.

A limitation of known designs is that the touch interface and the voice interface are implemented as two separate user interface mechanisms when it comes to the access of driver-restricted touch interface functions in a moving vehicle. Known designs do not take advantage of the voice recognition capability to present a seamless experience to the user when the user tries to access driver-restricted touch interface functionality. Instead, the user is left with an aborted task and has to initiate a voice recognition session using a PTT button in order to go through the dialog structure and complete the task.

FIG. 1 is a flow chart of a driver distraction lockout method 100 of the prior art. As indicated at 102, a display screen of an infotainment system of a motor vehicle presents a home page. In response to a user pressing a navigation pushbutton, as at 104, the display screen presents the navigation main page, as at 106. At 108, the user presses the “Enter Address” pushbutton. As indicated at 110, the user manually keys in the state as “Ohio” and the city as “Dayton”. However, before the user keys in the street name, the vehicle starts moving, as indicated at 112. Then, as indicated at 114, the display screen presents text indicating that the keying in function is not allowed because the vehicle is moving. Consequently, the user's inputs that he keyed in are lost.

### SUMMARY OF THE INVENTION

The invention may provide a user with an improved experience by minimizing the disruption caused by driver distraction lockout strategies using an embedded voice recognition system or an external or add-on device that is connected to the infotainment system. When user tries to initiate a driver-restricted function while the vehicle is moving, the present invention does not present an error message and does not abort the task. Instead of requiring the user to press the PTT button to initiate the voice recognition, the present invention automatically initiates the voice recognition system, presenting a seamless experience that results in completion of the task with no wasted effort.

The invention may ensure that the touch interface and the voice interface work together in such a way that the touch interface communicates its “context” to the voice interface so that the user is not required to go through dialogs, but instead directly reaches the stage of the speech dialog which enables the completion of the task that was restricted in the touch interface.

Under scenarios where the user has entered partial data while the vehicle is stationary, the present invention may ensure that the touch interface system communicates both the “context” and the “partial data” to the voice interface so that data entry effort is not wasted. The voice recognition system may go to the correct state of the speech dialog and may make use of the partial data that was input using the haptic interface. The voice recognition system then takes over to collect the remaining data from the user to complete the action.

The present invention may implement widget components in the user interface and novel features in the speech recognition application of the head unit. The present invention may assign an alphanumeric identification to all possible entries into the speech recognition system corresponding to various access points of driver-restricted functions in the touch interface. The present invention includes starting the speech recognition session by specifying the identification of the entry point so that the system directly proceeds to the corresponding state of the dialog. The present invention may ensure that the session can be initiated by providing additional data corresponding to the entry point. For example, the additional data may be a partial telephone number when the entry point is the phone number dial dialog.

The present invention may provide novel pushbutton widgets in the touch interface sub-system wherein these widgets check whether the conditions for driver restrictions exist when the user tries to use these widgets to access a driver-restricted function. If the conditions do exist, the pushbutton widget may automatically start the voice recognition system by communicating the identification that indicates that entry point for the voice recognition system. If the conditions for driver restriction do not exist, the push button widget allows access to the function. For example, if the user presses a “Dial” button in the user interface to access a key pad for entering a telephone number when the vehicle is in motion, instead of presenting an error message, the system may start a voice recognition session prompting the user to utter the telephone number that needs to be dialed.

The present invention may provide “screen” widgets in the touch interface sub-system wherein these widgets constantly monitor whether the conditions for driver restrictions exist. Whenever the widget detects that those conditions are met, the screen widget captures all the data on the screen, and starts the voice recognition system by communicating both the identification for the context and the partial data that the user has entered on the screen. For example, if the user has entered a partial address (e.g., city and state) in the destination entry screen and starts driving the vehicle, the present invention may automatically continue the task using the speech recognition system. The speech recognition system may use the city and state information that has been input using the touch interface. The speech recognition system may directly proceed to the dialog where the speech recognition system may prompt the user to enter the remaining part of the address including street name and house number.

The invention comprises, in one form thereof, a method of enabling a driver to provide inputs to a vehicle while driving, including installing a tactile input device within the vehicle. A first portion of a set of inputs is received from the driver via the tactile input device. An increase in difficulty of a driving task of the driver is sensed. In response to the sensing step, the driver is automatically audibly prompted to enter a second portion of the set of inputs via an auditory input device. The second portion of the set of inputs is received from the driver via the auditory input device.

The invention comprises, in another form thereof, an arrangement installed within a vehicle for enabling a driver to provide inputs to the vehicle while driving. The arrangement includes a tactile input device receiving a first portion of a set of inputs from the driver. An electronic processor is communicatively coupled to each of the tactile input device, an auditory input device, and a loudspeaker. The electronic processor senses an increase in difficulty of a driving task of the driver, and, in response to the sensing of the increase in difficulty of the driving task, uses the loudspeaker to automatically audibly prompt the driver to enter a second portion of the set of inputs via the auditory input device. The electronic processor receives the second portion of the set of inputs from the driver via the auditory input device.

The invention comprises, in yet another form thereof, a method of enabling a driver to provide inputs to a vehicle while driving, including installing a tactile input device within the vehicle. A first portion of a set of inputs is received from the driver via the tactile input device. After the receiving step, it is sensed that the vehicle is in motion. In response to the sensing step, subsequent inputs from the driver via the tactile input device are ignored. The driver is automatically audibly prompted to enter a second portion of the set of inputs via an auditory input device. The second portion of the set of inputs is received from the driver via the auditory input device.

An advantage of the present invention is that it may eliminate the need for the user to manually launch the voice recognition system when a speed lockout condition is detected.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a flow chart of a driver distraction lockout method of the prior art.

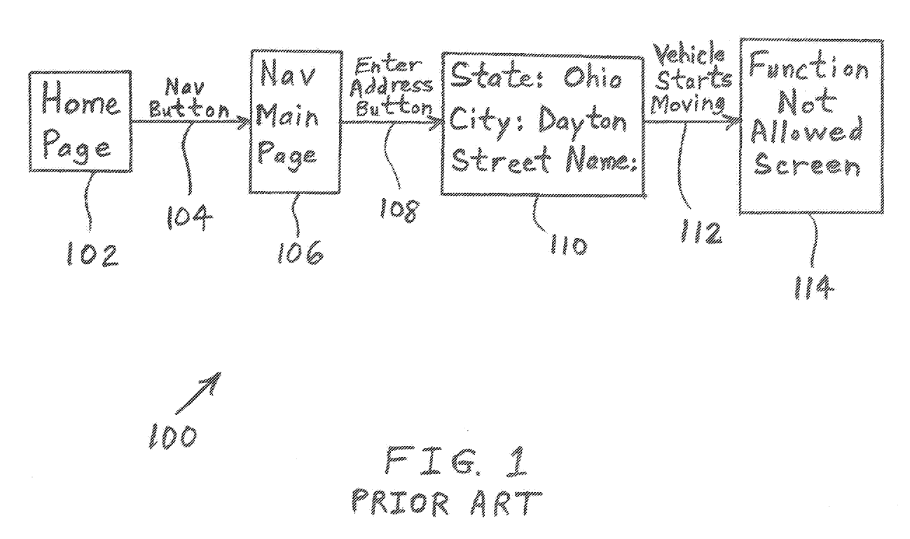

FIG. 2 is a flow chart of one embodiment of a driver distraction lockout method of the present invention.

FIG. 3 is a block diagram of one embodiment of an arrangement installed within a vehicle of the present invention for enabling a driver to provide inputs to the vehicle while driving.

FIG. 4 is a flow chart of one embodiment of a method of the present invention for enabling a driver to provide inputs to a vehicle while driving.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

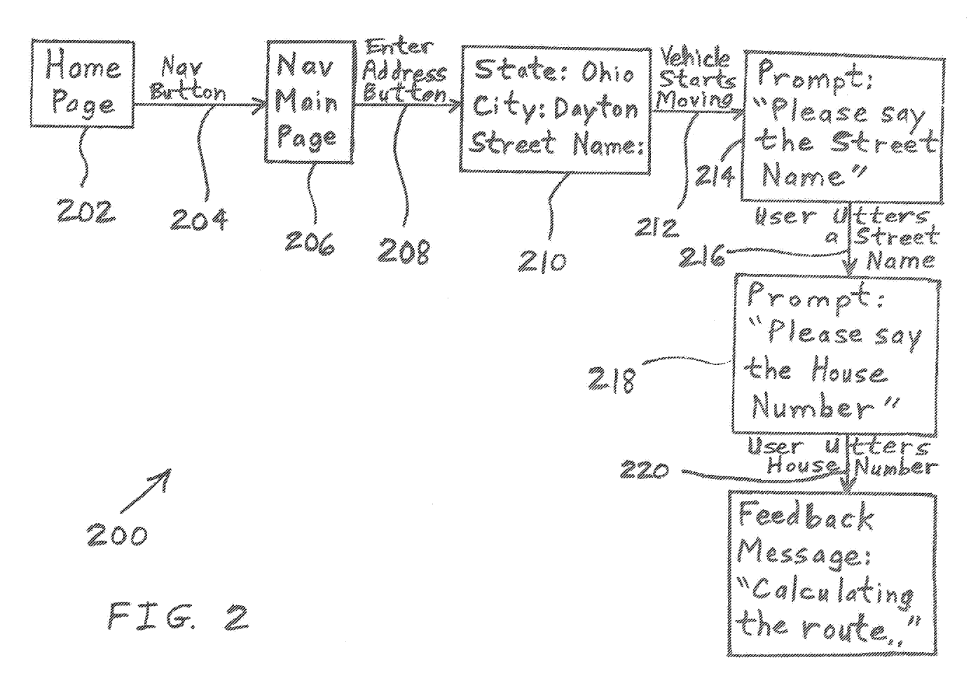

FIG. 2 is a flow chart of one embodiment of a driver distraction lockout method 200 of the present invention. As indicated at 202, a display screen of an infotainment system of a motor vehicle presents a home page. In response to a user pressing a navigation pushbutton, as at 204, the display screen presents the navigation main page, as at 206. At 208, the user presses the “Enter Address” pushbutton. As indicated at 210, the user manually keys in the state as “Ohio” and the city as “Dayton”. However, before the user keys in the street name, the vehicle starts moving, as indicated at 212. In response to detecting the movement of the vehicle, enablement of the touch interface ends and enablement of the speech interface begins. Thus, as indicated at 214, the speech interface audibly prompts the user to “Please say the street name.” In response to the prompt, the user utters a street name, as indicated at 216. In response to a microphone detecting the user's utterance, the speech interface audibly prompts the user to “Please say the house number”, as indicated at 218. In response to this second prompt, the user utters a house number, as indicated at 220. In response to a microphone detecting the user's utterance, the speech interface audibly provides the feedback message “Calculating the route . . . ”.

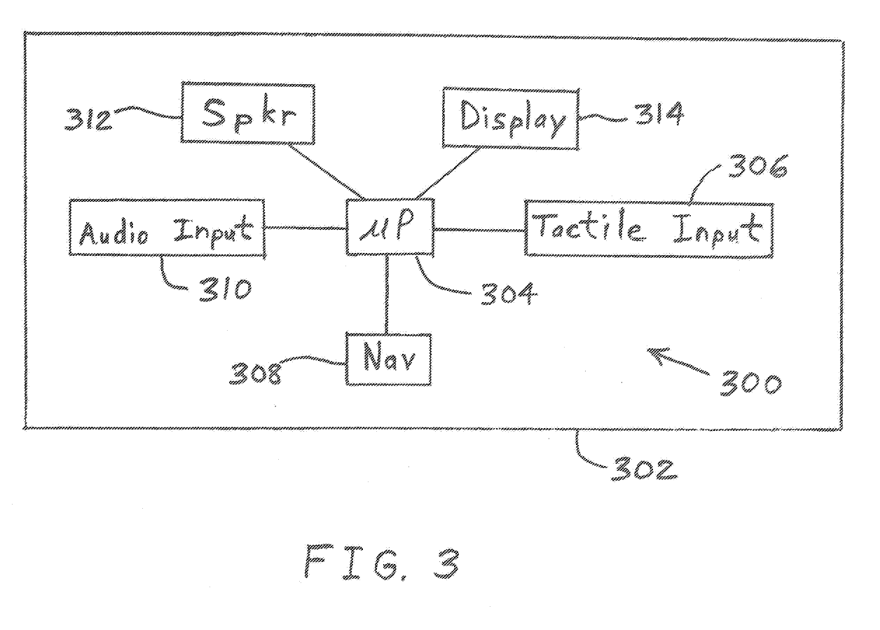

FIG. 3 illustrates an arrangement 300 installed within a vehicle 302 for enabling a driver to provide inputs to vehicle 302 while driving. Arrangement 300 includes an electronic processor 304 communicatively coupled to each of a tactile input device 306, a navigation system 308, an auditory input device 310, a loudspeaker 312, and a display screen 314. Tactile input device 306, which may include a set of pushbuttons, may receive a first portion of a set of inputs from the driver, perhaps in response to a textual prompt presented on display screen 314. The set of inputs may include inputs for navigation system 308. Electronic processor 304 may sense an increase in difficulty of a driving task of the driver, such as the vehicle going into motion. In response to the sensing of the increase in difficulty of the driving task, electronic processor 304 may use loudspeaker 312 to automatically audibly prompt the driver to enter a second portion of the set of inputs via auditory input device 310. Electronic processor 304 may receive the second portion of the set of inputs from the driver via auditory input device 310.

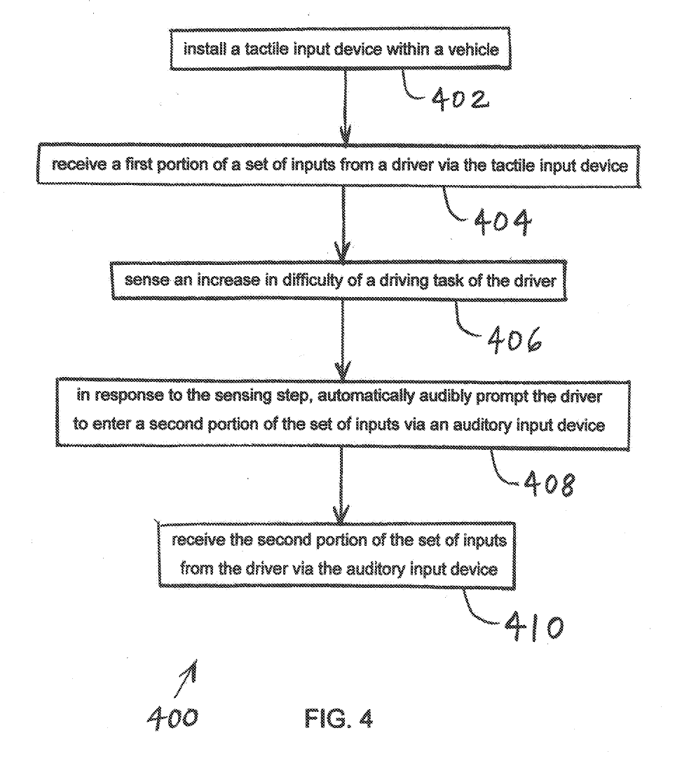

FIG. 4 illustrates one embodiment of a method 400 of the present invention for enabling a driver to provide inputs to a vehicle while driving. In a first step 402, a tactile input device is installed within a vehicle. For example, a tactile input device 306 such as a keyboard may be installed in vehicle 302.

In a next step 404, a first portion of a set of inputs is received from the driver via a tactile input device. For example, the driver may manually key in a partial address via tactile input device 306.

Next, in step 406, an increase in difficulty of a driving task of the driver is sensed. For example, commencement of movement of the vehicle may be sensed by a speedometer or GPS module.

In step 408, in response to the sensing step, the driver is automatically audibly prompted to enter a second portion of the set of inputs via an auditory input device. For example, as shown in step 214, the driver may be audibly prompted via speaker 312 to audibly speak the remainder of the address so that the remainder of the address is entered via an audio input device 310, such as a microphone.

In a final step 410, the second portion of the set of inputs is received from the driver via the auditory input device. For example, after the driver speaks the remainder of the address, processor 304 may receive a corresponding microphone signal from audio input device 310.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A method of enabling a driver to provide inputs to a vehicle while driving, the method comprising:
installing a tactile input device within the vehicle;
receiving a first portion of a set of inputs from the driver via the tactile input device;
sensing an increase in difficulty of a driving task of the driver;
in response to the sensing step, automatically audibly prompting the driver to enter a second portion of the set of inputs via an auditory input device; and
receiving the second portion of the set of inputs from the driver via the auditory input device.

2. The method of claim 1, wherein the tactile input device includes at least one pushbutton.

3. The method of claim 1, wherein the sensing step comprises detecting that the vehicle is in motion.

4. The method of claim 1, wherein the auditory input device comprises a microphone.

5. The method of claim 1, wherein the set of inputs comprises inputs into a navigation system.

6. The method of claim 1, wherein the automatically audibly prompting of the driver comprises providing spoken instructions to the driver.

7. The method of claim 1, comprising the further steps of:
in response to the receiving of the second portion of the set of inputs from the driver, automatically audibly prompting the driver to enter a third portion of the set of inputs via the auditory input device; and
receiving the third portion of the set of inputs from the driver via the auditory input device.

8. An arrangement installed within a vehicle for enabling a driver to provide inputs to the vehicle while driving, the arrangement comprising:
a tactile input device configured to receive a first portion of a set of inputs from the driver;
an auditory input device;
a loudspeaker; and
an electronic processor communicatively coupled to each of the tactile input device, the auditory input device, and the loudspeaker, the electronic processor being configured to:
sense an increase in difficulty of a driving task of the driver;
in response to the sensing of the increase in difficulty of the driving task, use the loudspeaker to automatically audibly prompt the driver to enter a second portion of the set of inputs via the auditory input device; and
receive the second portion of the set of inputs from the driver via the auditory input device.

9. The arrangement of claim 8, wherein the tactile input device includes at least one pushbutton.

10. The arrangement of claim 8, wherein the electronic processor is configured to sense the increase in difficulty of the driving task step by detecting that the vehicle is in motion.

11. The arrangement of claim 8, wherein the auditory input device comprises a microphone.

12. The arrangement of claim 8, further comprising a navigation system communicatively coupled to the electronic processor, wherein the set of inputs comprises inputs into the navigation system.

13. The arrangement of claim 8, wherein the electronic processor is configured to use the loudspeaker to automatically audibly prompt the driver by providing spoken instructions to the driver.

14. The arrangement of claim 8, wherein the electronic processor is configured to:
respond to the receiving of the second portion of the set of inputs from the driver by using the loudspeaker to automatically audibly prompting the driver to enter a third portion of the set of inputs via the auditory input device; and
receive the third portion of the set of inputs from the driver via the auditory input device.

15. A method of enabling a driver to provide inputs to a vehicle while driving, the method comprising:
installing a tactile input device within the vehicle;
receiving a first portion of a set of inputs from the driver via the tactile input device;
after the receiving step, sensing that the vehicle is in motion;
in response to the sensing step, ignoring subsequent inputs from the driver via the tactile input device and automatically audibly prompting the driver to enter a second portion of the set of inputs via an auditory input device; and
receiving the second portion of the set of inputs from the driver via the auditory input device.

16. The method of claim 15, wherein the tactile input device includes at least one pushbutton.

17. The method of claim 15, wherein the auditory input device comprises a microphone.

18. The method of claim 15, wherein the set of inputs comprises inputs into a navigation system.

19. The method of claim 15, wherein the automatically audibly prompting of the driver comprises providing spoken instructions to the driver.

20. The method of claim 15, comprising the further steps of:
in response to the receiving of the second portion of the set of inputs from the driver, automatically audibly prompting the driver to enter a third portion of the set of inputs via the auditory input device; and
receiving the third portion of the set of inputs from the driver via the auditory input device.
